(19) United States
(12) Patent Application Publication
(10) Pub. No.: US 2009/0316119 A1
(43) Pub. Date: Dec. 24, 2009

(54) Apparatus and method for conditioning an immersion fluid

(76) Inventors: Bipin S. Parekh, Chelmsford, MA (US); Annie Xia, Lynnfield, MA (US); Michael Clarke, Bedford, MA (US); Joseph E. Smith, North Andover, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 12/309,202

(22) PCT Filed: Jul. 18, 2007
(86) PCT No.: PCT/US2007/016232

§ 371 Date: Jan. 9, 2009

Related U.S. Application Data
(60) Provisional application No. 60/832,472, filed on Jul. 21, 2006.
(60) Provisional application No. 60/931,275, filed on May 21, 2007.

(51) Int. Cl. G03B 27/52; G03B 27/32

(52) U.S. Cl. 355/30; 355/77

(57) ABSTRACT

The present invention includes apparatus and methods for producing a conditioned immersion fluid for use in an immersion lithography process. The conditioned immersion fluid protects the immersion system lens and reduces or eliminates deposition of contaminants onto the lens that can adversely affect the lens transmission and durability of an immersion lithography system.

### RELATED APPLICATIONS

This application claims the benefit of U.S. Provisional Patent Application No. 60/931,275, filed May 21, 2007, entitled “Apparatus and Method for Conditioning an Immersion Fluid,” and U.S. Provisional Patent Application No. 60/832,472, filed Jul. 21, 2006, entitled “Apparatus and Method for Conditioning an Immersion Fluid,” the entire teachings of each of which are incorporated herein by reference.

### BACKGROUND OF THE INVENTION

Water immersion lithography is a process that will allow the continued reduction in feature size of semiconductor devices. Replacing air with water as the media between the lens and the wafer increases the refractive index of the media to a value near the refractive index of the lens and improves lithographic resolution. Water immersion lithography allows laser light, such as 193 nanometer (nm) laser light, to be used to produce finer geometries than would be possible using conventional lithography.

While water immersion lithography has a number of advantages over conventional lithography, it has its own series of technical challenges. One particular challenge is supplying a water immersion media that is suitably free of contaminants that would otherwise produce defects during the exposure process.

A typical water immersion lithography system has several unit operations that work to provide water suitable as the immersion media. The primary unit operations can include, for example, pumping, total oxidizable carbon (TOC) reduction, dissolved oxygen removal, temperature control, and particle control. Each unit operation, however, provides an opportunity for further contamination of the immersion media.

For immersion lithography, the liquid (e.g., water) quality utilized maintains the optical properties of the liquid at the highest level of clarity (low absorbance) and purity (parts per trillion (ppt) levels of contaminants) to ensure high transmission of imaging radiation through the liquid and lens. For example, the 193 nm optical absorbance in high purity water is typically 0.01/cm and varies strongly with the trace amounts of absorbing extrinsic impurities.

Colloidal silica, including colloidal silica in very fine particulate form (e.g., as small as 2-3 nanometers in diameter), is of great importance to the semiconductor industry. The fabrication of very large scale integrated (VLSI) circuits involves multiple semiconductor wafer surface processing stages, with each stage typically followed by a washing of the wafer with ultrapure water. Despite the frequency of washings, and the attendant care with which the ultrapure water is monitored, colloidal silica and other impurities can accumulate on the wafer, leading to defects in the resulting semiconductor device.

Colloidal silica is difficult to detect, particularly when in very fine particulate form. Such colloidal silica cannot be detected by a scanning electron microscope (SEM), but requires a substantially more expensive scanning tunneling microscope. Alternatively, colloidal silica can be detected by atomic absorption spectrometry to measure a total amount or proportion of silica, with conventional means employed to measure dissolved silica, with colloidal silica then being the total silica less the dissolved silica. Silica is unique in that its presence in DI water cannot be detected by either pH or conductivity-criteria normally employed to measure water purity.

Silica can exist in water as a suspended solid, colloid, as a complex formed with iron, aluminum and organics, as a polymer and as a soluble/reactive species. Major factors, which affect the solubility of silica, are temperature, pH, nature of solid phase, and pressure. At pH levels of water, usually in the range of 6-8.5, silica exists as a molecular species, H₄SiO₄, or as H₂SiO₃ (ortho or meta silicic acid). These are very weak acids (pKa=9.4) and are present in water as non-ionized species.

As the concentration of silica in the water increases, the silica will frequently polymerize, forming dimers, trimers, tetramers, etc. Polymerization can proceed to the extent that the silica passes through the soluble to the colloidal state and may eventually form insoluble gel. Silica in UPW typically exists in the following two main forms: dissolved silica (chemical form) and colloidal silica (physical form: typical size<0.1 micron). Dissolved silica and colloidal silica are interchangeable depending on the water's acidity.

Large amounts of ultrapure water are used in processes to manufacture semiconductors, and boron may be present as a contaminant in the raw or pretreated feed water. Boron is a p-type semiconductor dopant used in manufacture of solid state electronics, and it functions as a principal charge carrier in the doped silicon crystal. The presence of boron even at a sub-part per billion (ppb) level in a fab plant process fluid, such as developer, cleaning fluid, vapor, rinse water or the like can give rise to surface deposits of boron, which in turn, may become incorporated in a silicon substrate during various process stages—particularly heating or ion implantation stages, and may change the intended dopant profile or otherwise alter the electrical characteristics of the substrate.

In immersion lithography, water drop residue has been identified as a potential source of defects. Many methods have been studied to reduce water drops outside of the immersion area. However, from a physical point of view, the wafer surface is very hard to keep dry after immersion exposure. The water drop residues easily cause watermark defects that range from micrometer-size circular defects to sub-micron scum defects.

### SUMMARY OF THE INVENTION

The present invention includes apparatus and methods for producing a conditioned immersion fluid for use in an immersion lithography process. The conditioned immersion fluid protects the immersion system lens and reduces or eliminates deposition of contaminants onto the lens that can adversely affect the lens transmission and durability of an immersion lithography system.

In some embodiments, the invention includes an apparatus having a flow path which includes: (a) an inlet conduit that supplies a pressurized source of feed liquid (e.g., water such as degassed feed water) to the apparatus; (b) an oxidation unit having an inlet for receiving a first flow of liquid and for degrading all or a portion of organic contaminants in the first flow into oxidation degradation products to thereby produce a liquid containing oxidation degradation products through an outlet of the oxidation unit, wherein the oxidation degradation products include carbon dioxide; (c) a high purity degasser having an inlet for receiving the liquid containing oxidation degradation products, the degasser for removing all or a portion of the oxidation degradation products from the liquid containing oxidation degradation products to thereby produce a second flow of liquid; (d) a purifier having an inlet for receiving the second flow of liquid, the purifier including a bed of material for removing from the second flow contaminants not degraded by the oxidation unit, the purifier further including an ion exchange bed (e.g., a mixed ion exchange bed containing cation and anion exchange resin), the ion exchange bed for removing ionic contaminants from the second flow, the purifier having an outlet for removing a third flow of liquid from the purifier; (e) a particle filter for removing particulates, colloids, gels or a combination of these from the third flow of the liquid to produce a fourth flow of liquid; and (f) a high purity thermoplastic heat exchanger having an inlet for receiving the fourth flow of liquid, the heat exchanger for conditioning the temperature of the fourth flow through a thermoplastic polymer (e.g., to a temperature for use in an immersion lithography lens) to thereby form a temperature-conditioned liquid; the heat exchanger having an outlet to remove all or a portion of the temperature-conditioned liquid from the exchanger to a point of use. In some embodiments, the feed liquid has less than about 200 parts per billion (ppb) dissolved oxygen. One particular order of devices within the flow path has been described supra. In other embodiments, the order of the devices within the flow path can be rearranged. For example, in one embodiment, a flow of liquid from the high purity degasser is directed to the particle filter and a flow of liquid from the particle filter is directed to the purifier to produce the fourth flow of liquid.

The invention includes a method which can comprise: (a) supplying a pressurized source of feed liquid (e.g., water such as degassed water); (b) directing the feed liquid into an oxidation unit having an inlet that receives a first flow of liquid and degrades all or a portion of organic contaminants in the first flow into oxidation degradation products thereby producing a liquid containing oxidation degradation products, the oxidation degradation products including carbon dioxide, and removing the liquid containing oxidation degradation products from the oxidation unit; (c) contacting the liquid containing oxidation degradation products with a high purity thermoplastic degasser having an inlet that receives the liquid containing oxidation degradation products and removing all or a portion of the oxidation degradation products from the liquid using the high purity thermoplastic degasser, thereby producing a second flow of liquid; (d) directing the second flow of liquid through a purifier bed having a material that removes contaminants not degraded by the oxidation unit and removing ionic contaminants by contacting the liquid with a ion exchange bed (e.g., a mixed ion exchange bed containing cation and anion exchange resin), the ion exchange bed removing ionic contaminants, thereby forming a third flow of liquid; (f) filtering the third flow of liquid to remove particulates, colloids, gels or a combination of these thereby forming a fourth flow of liquid; and (g) conditioning the temperature of a fourth flow of liquid with a high purity thermoplastic heat exchanger having an inlet to receive the fourth flow, the heat exchanger conditioning the temperature of the fourth flow of liquid through a thermoplastic polymer in contact with an exchange fluid (e.g., a degassed exchange fluid) thereby forming a temperature-conditioned liquid; the heat exchanger having an outlet to remove all or a portion of the temperature-conditioned liquid from the exchanger to a point of use. In one embodiment, the feed liquid has a resistivity in the range of about 17 to about 18.2 mega-ohms at 25° C. In some embodiments, the feed liquid contains less than about 200 parts per billion dissolved oxygen. One particular order of the steps of the method has been described supra. In other embodiments, the order of the steps can be rearranged. For example, in one embodiment, the second flow of liquid from the high purity degasser is filtered to remove particulates, colloids, gels or a combination of these thereby forming a third flow of liquid and the third flow is directed through the purifier bed to form a fourth flow of liquid.

Embodiments of the invention include an apparatus having a flow path that can comprise or that can include an inlet conduit that supplies a pressurized source of feed liquid (e.g., feed water such as degassed feed water) to the apparatus, the feed liquid having less than about 200 parts per billion dissolved oxygen. The apparatus can include an oxidation or degradation unit having an inlet that receives a flow of feed liquid and degrades all or a portion of organic contaminants in the feed liquid into oxidation degradation products, for example, oxidation degradation products that can include carbon dioxide. The oxidation or degradation unit has a fluid inlet and a fluid outlet and can use one or more sources of energy such as ultraviolet light to degrade organic contaminants.

The apparatus can further include a high purity degasser having an inlet that receives feed liquid (e.g., feed water such as degassed feed water) containing oxidation degradation products. The degasser, for example, by vacuum degassing or stripping, can remove all or a portion of volatile oxidation degradation products from the feed liquid. The high purity degasser contributes few or no organic contaminants to the feed liquid that would adversely affect use of the treated liquid in an immersion lithography application. In some versions, the high purity degasser contains microporous hollow fibers or perfluorinated microporous hollow fibers.

The apparatus may further include a purifier having an inlet that receives feed liquid (e.g., feed water such as degassed feed water) and removes from the feed liquid contaminants harmful to an immersion lithography process that have not been degraded by the oxidation unit. The purifier can include an ion exchange bed for removing ionic contaminants from the feed liquid. In one embodiment, the ion exchange bed is a mixed ion exchange bed and includes cation and anion exchange resin. In another embodiment, the ion exchange bed includes only either cation exchange resin or anion exchange resin. The purifier can include other bed layers for removing contaminants. The purifier has an outlet for removing said feed liquid from the purifier. The purifier and ion exchange bed can be in a single housing or separated into one or more housings. In some versions of the apparatus, the purifier material is upstream of the ion exchange bed. In other embodiments, the ion exchange bed is upstream of the purifier material.

The apparatus can include one or more particle filters that remove particulates, colloids, gels, or a combination of these from a feed liquid (e.g., feed water such as degassed feed water). In one embodiment, these particulates are particulates which were not removed by the purifier, ion exchange bed, or degraded by the oxidation unit. In some embodiments, one or more of the particle filters include a microporous membrane. The microporous membrane of the particle filter can be charged or uncharged. In one embodiment, the microporous membrane is a plastic material.

The apparatus also can include a high purity thermoplastic heat exchanger having an inlet to receive feed liquid (e.g., feed water such as degassed feed water). The heat exchanger conditions the temperature of the feed liquid through a thermoplastic polymer that fluidly separates the feed liquid from a heat exchange fluid. In one embodiment, the heat exchange fluid has been deaerated or degassed. In some versions the heat exchanger contains one or more hollow tubes such as perfluorinated thin walled hollow tubes. The feed liquid can be conditioned to a temperature for use in an immersion lithography system. The heat exchanger has an outlet to remove all or a portion of temperature conditioned liquid from the exchanger to a point of use, e.g., a liquid immersion lithography system.

In some versions of the invention, the apparatus can also include a degasser (e.g., a polishing degasser) to remove bubbles and/or dissolved gases from the feed liquid which may not have been previously degassed to a level suitable for use in immersion lithography. Further, as illustrated in FIGS. 1A and 1B, the apparatus can further be configured in a re-circulation or feed and bleed configuration. Thus, in some embodiments, the apparatus can also include a pump to re-circulate all or a portion of the fluid through a purifier and/or a high purity heat exchanger.

The present invention also includes a method for conditioning an immersion fluid for use of the liquid in an immersion lithography process. The method can include or comprise the acts or steps of supplying a pressurized source of degassed feed liquid (e.g., water) to the apparatus or degassing a feed liquid (e.g., water) source. The degassed feed liquid can have, for example, a resistivity in the range of about 17 to about 18.2 Mohms-cm at 25° C. The degassed feed liquid can contain, for example, less than about 200 parts per billion dissolved oxygen.

In the method for conditioning an immersion fluid, the feed liquid (e.g., degassed feed water) can flow into an oxidation or degradation unit having an inlet that receives said feed liquid and degrades all or a portion of organic contaminants in the feed liquid into degradation products. The degradation products can include carbon dioxide or other volatile by-products. The liquid containing degradation products from an outlet of the oxidation or degradation unit can be further treated by contacting the liquid containing oxidation degradation products with a high purity thermoplastic degasser having an inlet that receives said liquid containing oxidation degradation products and removes all or a portion of the volatile degradation products from the liquid, for example, by vacuum degassing, gas stripping, or a combination of these.

The method can further include flowing feed liquid (e.g., degassed feed water) through a purifier bed having a material that removes contaminants harmful to an immersion lithography process. In one embodiment, contaminants not degraded by the oxidation or degradation unit are removed from the feed liquid. The method can include removing ionic contaminants from the feed liquid by contacting the feed liquid with an ion exchange bed. The ion exchange bed removes ionic contaminants from said feed liquid. In one embodiment, the ion exchange bed is a mixed ion exchange bed and includes cation and anion exchange resin. In another embodiment, the ion exchange bed includes only either cation exchange resin or anion exchange resin. The resulting purified liquid can be filtered by flowing the liquid into a filter to remove particulates, colloids, gels or a combination of these from the liquid.

The method can also include conditioning the temperature of the feed liquid (e.g., degassed feed water) with a high purity thermoplastic heat exchanger having an inlet to receive feed liquid. The heat exchanger can receives feed liquid and can condition the temperature of the feed liquid through a thermoplastic polymer in contact with a heat exchange fluid (e.g., a degassed heat exchange fluid). In some versions of the method, the high purity heat exchanger contains perfluorinated thin walled hollow tubes. The feed liquid can be conditioned to a temperature and range of stability for use in an immersion lithography system or process. The heat exchanger has an outlet to transport all or a portion of the temperature conditioned liquid from the exchanger to a point of use, e.g., an immersion lithography system.

In some versions of the method, the purifier bed is between the outlet of the high purity degasser and the inlet of the ion exchange bed. In some versions of the method, the high purity thermoplastic heat exchanger conditions the temperature of feed liquid that has been treated by the purifier bed.

Versions of the invention remove contaminants from liquids (e.g., water) to trace levels at the point of use (POU) to achieve high process effectiveness for immersion lithography. A POU UPW (ultra high purity water) system can be used to further purify and upgrade high purity fab water to a higher quality, containing lower impurities, and deliver it to the immersion lithography tool lens. Impurities can be added to UPW in the fab water from the semiconductor manufacturing process materials and piping components.

Versions of the invention further provide temperature and flow control that can eliminate or reduce microbubbles in the liquid (e.g., water) and at the interface between the liquid and coated substrate. Temperature control of immersion liquid, like water treated by an apparatus in versions of the invention, can be used to ensure that the refractive index, density, surface tension and gas solubility remain stable.

Embodiments of the invention provide treated immersion fluid that can be used in an immersion lithography process and can further protect the lens and can reduce, eliminate, or prevent deposition of contaminants that can adversely affect the lens transmission and durability of an immersion lithography system.

In some versions of the apparatus and method, the purifier removes boron. For certain industrial applications, such as semiconductor manufacture, boron levels below about 100 ppt (parts per trillion) can be made. Reduction in boron levels can improve semiconductor yields because even very low levels of boron present in the deionized UPW product water used in manufacturing can significantly and adversely affect the quality and performance of a semiconductor chip.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A illustrates an embodiment of the invention where the purifier includes a resin for removing a contaminant not oxidized or charged and a mixed bed of ion exchange resins; FIG. 1B illustrates an embodiment of the invention where the apparatus includes separate beds of purifier and mixed bed ion exchange resin. The apparatus may optionally include a degasser to degas feed water to the apparatus and the filter may optionally be a charged or hydrophilic microporous membrane.

FIG. 2 shows a single pass purification process according to one embodiment of the present invention.

FIGS. 3A and 3B illustrate test results for Example 2.

FIG. 4 illustrates an embodiment and flow path of an apparatus of the invention having one or more heat exchangers, purifier or ion exchange beds, oxidation units, charged filter, and degassers. An outlet Si purifier sample collection port can be connected to a point of use such as an immersion lithography system.

FIGS. 5A and 5B illustrate experimental results for the embodiment of FIG. 4

FIG. 6 illustrate temperature conditioning achieved with high purity heat exchangers used in embodiments of the invention.

FIGS. 7A and 7B illustrate data from a non-limiting embodiment of an apparatus of this invention of FIG. 4; The resistivity of the immersion fluid, water, is about 18.2 to about 18.25 Mohms-cm. TOC can be less than about 4 parts per billion (ppb).

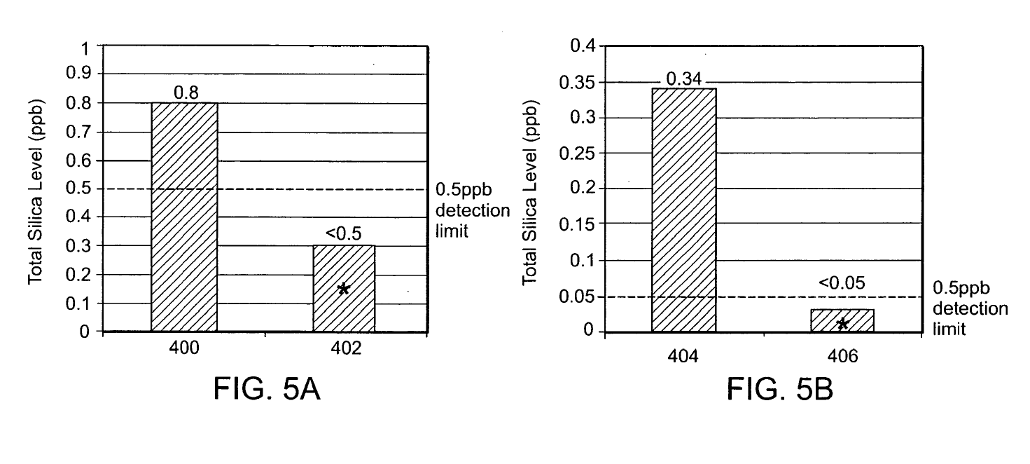

FIGS. 5A, 8B, and 8C are charts of degassed feed water inlet pressure, pump outlet pressure, and high purity water outlet pressure, respectively, over time for one embodiment of the present invention.

FIG. 9 contains charts of degassed feed water inlet pressure and high purity water outlet pressure over time for one embodiment of the present invention.

FIG. 10 shows particle count greater than 0.05 μm as a function of time during various experiments in which three different particle filters were installed in a single pass purification process according to several embodiments of the present invention.

### DETAILED DESCRIPTION OF THE INVENTION

A description of example embodiments of the invention follows.

In immersion lithography, the space between the lens and the substrate is filled with a liquid, commonly referred to as an immersion fluid, that typically has a refractive index greater than 1. The immersion fluid should have a low optical absorption at the operating wavelength such as, for example, 193 nm and 157 nm, be compatible with the photoresist and the lens material, be uniform, and be non-contaminating. An immersion fluid for 193 nm immersion lithography is ultra pure water (UPW). Ultra pure water has an index of refraction of approximately 1.44, exhibits absorption of less than about 5% at working distances of up to 6 mm, is compatible with photoresist and lens, and is non-contaminating in its ultra pure form. Still other immersion fluids that have been considered for 157 nm immersion lithography include KRYTOX® (a trademark of E. I. Du Pont De Nemours and Co., Wilmington, Del.) and perfluoropolyether (PFPE).

A liquid immersion lithography system can include a light source, an illumination system (e.g., a condenser), a photomask, and an objective lens. An immersion liquid is used with the system to aid in the formation of a pattern on a semiconductor substrate. The light source may be any suitable light source. For example, the light source may be a mercury lamp having a wavelength of 436 nm (G-line) or 365 nm (I-line); a Krypton Fluoride (KrF) excimer laser with wavelength of 248 nm; an Argon Fluoride (ArF) excimer laser with a wavelength of 193 nm; a Fluoride (F₂) excimer laser with a wavelength of 157 nm; or other light sources having a wavelength below approximately 100 nm.

An immersion liquid can have an index of refraction larger than one, relatively low optical absorption at a predetermined patterning wavelength such as 193 nm, and is compatible with a photoresist applied to the semiconductor substrate. In addition, the immersion liquid can be chemically stable, uniformly composed, non-contaminating, bubble-free, and thermally stable. As an example, pure water can be used as an immersion liquid. Further, the temperature of the immersion liquid can be controlled to reduce variation in the index of refraction of the liquid.

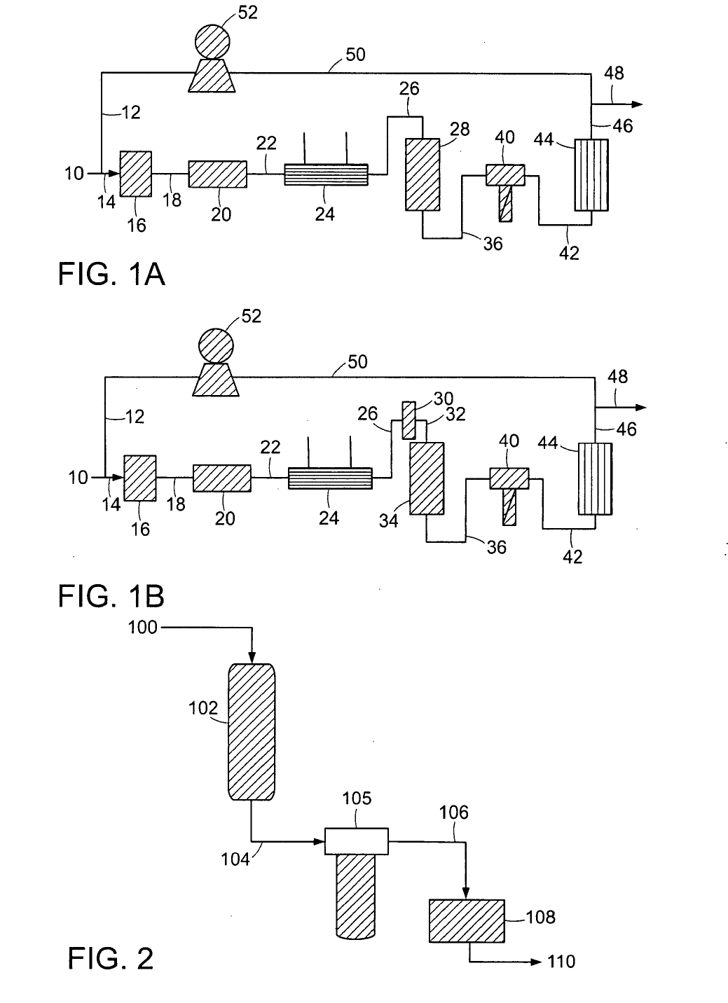

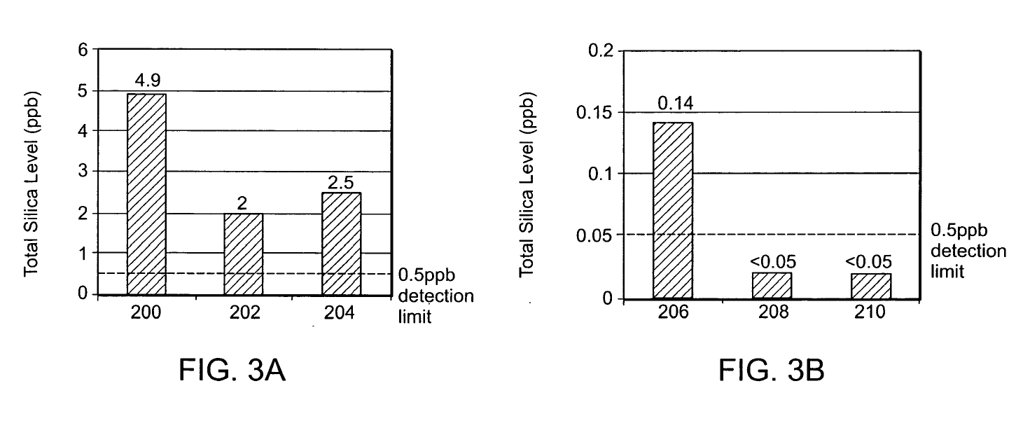

In FIG. 1A, the flow path of a version of the apparatus is illustrated. Feed liquid 10, which can include house water, e.g., ultrapure water, or other liquid feed such as used immersion fluid from a lithography system, can combine with recirculated liquid 12 to form stream 14. Stream 14 can flow into degasser 16, which can be optional, wherein stream 14 is degassed to a sufficient level from feed liquid 10. Degassed feed water 18 can flow into a degradation unit 20, for example, UV oxidation unit where oxidizable carbon containing contaminants are degraded. UV-treated degassed water 22 can then pass into high purity degasser 24 where volatile degradation products, such as but not limited to carbon dioxide, are removed from UV-treated degassed water 22 to produce degassed liquid 26. This second or polishing degassing can utilize a high purity (e.g., low TOC such as less than 20 parts per billion (ppb)) and low ionic extractables (see e.g., table describing degasser extractables herein) degasser which can include a plurality of perfluorinated hollow fibers. In one embodiment, high purity degasser 24 is a polishing degasser. Degassed liquid 26, with all or a portion of the volatiles degradation products removed, flows into purifier 28. Purifier 28 has an inlet that receives degassed liquid 26 and includes a bed of purifier material that removes from the degassed feed water contaminants not degraded by the oxidation unit and that are harmful to an immersion lithography process, to produce purified liquid stream 36. Purifier 28 can include an ion exchange material, e.g., anion or mixed anion/cation ion exchange material. Purifier 28 can also include a bed of material that is a separate region from an ion exchange material within the purifier housing. In another embodiment, illustrated in FIG. 1B, degassed liquid 26 flows into purifier 30 to form stream 32, stream 32 flows into ion exchange bed 34 (containing an ion exchange material, e.g., anion or mixed anion/cation ion exchange material) to produce purified liquid stream 36. In either embodiment, the ion exchange material can contain cation and anion exchange resin that removes ionic contaminants from the degassed water which has been UV oxidized and degassed to remove volatile degradation products, e.g., degassed liquid 26. Purified liquid stream 36, the outlet from the purifier or ion exchange bed, is fed to optional particle filter 40. Particle filter 40 can remove colloids, gels and other particulate not removed by purifier 28 or 30, ion exchange bed 34, or degradation unit 20. Stream 42, which has been UV oxidation treated, purified, degassed, and ion exchanged, flows into high purity heat exchanger 44, e.g., a perfluorinated heat exchanger containing a plurality of hollow tubes fusion bonded or potted in the device. In one embodiment, stream 42 is fed to a plurality of perfluorinated hollow tubes contained within high purity heat exchanger 44. High purity heat exchanger 44, for example, one or more PHASOR® heat exchangers from Entegris Inc., can transfer heat between deaerated exchange fluid from a chiller/heater (not shown but see FIG. 3 for an example) and stream 42. Heat exchanger 44 conditions the temperature of stream 42 to a temperature range that provides a stable refractive index for the water for use in an immersion lithography system. Heat exchanger 44 has an outlet to remove all or a portion of temperature conditioned degassed water from the exchanger. In one embodiment, treated immersion fluid 46 is removed from the exchanger. Treated immersion fluid 46 can be directed to a point of use in its entirety. In another embodiment, treated immersion fluid 46 is split into streams 48 and 50. Stream 48 is then directed to a point of use and stream 50 is recirculated through recirculation pump 52 to form stream 12. In one embodiment, stream 12 can then be mixed with feed liquid 10. In some embodiments, the apparatus can be used in a single pass, see for example, the embodiment described in Example 2, the apparatus can be configured as shown in FIGS. 1A and 1B, to re-circulate the treated liquid while diverting a portion, stream 48, to an immersion lithography system.

In one embodiment of the invention, a liquid (e.g., water) purification system or apparatus includes bulk degassing, UV oxidation, polishing degassing with a high purity thermoplastic degasser, silica removal, ion exchange purification, about 0.03 micron or smaller filtration, and temperature conditioning of the water using low TOC (total oxidizable carbon) emitting heat exchangers that provide temperature control to less that about 0.01° C. and maintain the resistivity of the water greater than about 18.2 Mohms-cm. Optionally, the apparatus can further include sensors for measuring dissolved gases (e.g., oxygen), pH, TOC, resistivity, or any combination of these.

In one embodiment, ion exchange purification includes one or more ion exchange beds. An ion exchange bed can include a mixed bed exchange resin, e.g., a mixture of cation and anion exchange resin such as an exchange resin with a 1:1:cation:anion ratio. In another embodiment, the ion exchange bed includes either a cation exchange resin or an anion exchange resin. In one embodiment, the size of the beds is about 2 inches in diameter and about 24 inches in length. Other sizes can be used and can be chosen based upon the process flow rate, pressure drop requirements, and input feed water impurity levels. In some versions of the apparatus, an anion exchange resin in the ion exchange bed and an anion exchange material in a purifier can be the same or different and the relative amounts can be chosen for a particular incoming feed liquid (e.g., feed water) composition. The purifier or ion exchange material can also include a carbon removing material, or a resin that removes both TOCs and ions such as ORGANEX™ resin from Millipore Corporation or other similar material. In some versions of the invention a silica purifier (Si purifier) (silica is an example of a contaminant harmful to the immersion lithography process that is not degraded by the oxidation unit) can be provided as a layer of purifier material upstream of the ion exchange bed. The purifier material can be in the same or a different housing or other suitable configuration.

The oxidation or degradation unit can include one or more UV lamps having a wavelength that decomposes oxidizable organic compounds typically found in the feed water. In some versions, for example, the UV lamps can be model SL-10A, greater than 30,000 microwatt seconds/cm², with a peak wavelength of 185 nm. In some cases, a UV lamp may emit a one or more wavelengths, for example, a mixture of 254 and 185 nm wavelength light. The power and wavelength of the lamps or other energy source can be chosen to degrade one or more contaminants in the liquid feed, e.g., water.

Based upon the flow rates of the water or other immersion liquid, one or more low TOC emitting degassers can be used to remove carbon dioxide, volatile degradation products, or other soluble gases from the immersion liquid downstream of the UV lamps or other degradation unit. In some versions the degassers contain perfluorinated microporous membrane to reduce or eliminate bubbles and dissolved gases originating from sources such as but not limited to dissolved gas in the feed liquid (e.g., UPW), the immersion lithography scanning process, gasses/bubbles generated by the UV oxidation source, or any combination of these. Bulk degassing of the feed liquid from the plant can optionally be performed using polyolefin or other similar microporous membranes. Degassing can be achieved, for example, by vacuum degassing, inert gas stripping, or any combination of these.

The degassers, which can be optional, can be used to remove the dissolved gasses from the immersion fluid being treated in the apparatus to parts per billion (ppb) levels. These degassers are preferably high purity, clean devices with low total oxidizable carbon (TOC, normally found in a Celgard hollow fiber degasser) extractables and particle shedding. These conventional, non-TEFLON® or non-perfluorinated material degassers are efficient at typical flow rates (e.g., greater than 75% efficient) but may have some TOC extractables, and can be used upstream of the oxidation or degradation unit, as roughing degassers. (TEFLON® is a trademark of E. I. Du Pont De Nemours and Co., Wilmington, Del.) These degassers can include, for example, flat sheet or hollow fiber microporous membranes.

TEFLON® or perfluorinated material membrane degassers can be greater than about 40% efficient and their cleaner design can make them suitable for use after the oxidation or degradation unit. These degassers can include flat sheet or hollow fiber microporous membranes. Metallic extractables data show the superior cleanliness of the TEFLON® or perfluorinated material degasser. See e.g., results of 10% HCl extraction for a PHASOR® membrane contactor from Entegris, Inc. in Table 1 below (PHASOR® is a trademark of Entegris, Inc., Chaska, Minn.). TEFLON® or perfluorinated material membrane degassers are generally high purity, clean devices with low total oxidizable carbon (TOC) extractables and particle shedding. In some embodiments, the degassers contribute less than about 200 ppb TOC and metal extractables, and in other embodiments less than about 20 ppb TOC and metal extractables.

TABLE 1
Extractables from Perfluorinated Degasser

| | Control | | Conventional |
|---|---|---|---|
| | (Lab UPW) | PHASOR ® | Degasser |
| Na (ppb) | <DL | <DL | 33.97 |
| Mg (ppb) | <DL | <DL | 17.63 |
| Al (ppb) | <DL | <DL | 3.34 |
| K (ppb) | 0.11 | <DL | 7.46 |
| Ca (ppb) | 0.06 | 0.22 | 13.29 |
| Ti (ppb) | <DL | <DL | 0.17 |
| Cr (ppb) | 0.01 | <DL | 0.05 |
| Mn (ppb) | 0.01 | <DL | 0.09 |
| Fe (ppb) | 0.01 | 6.25 | 0.75 |
| Ni (ppb) | <DL | 1.90 | 3.66 |
| Cu (ppb) | <DL | 2.04 | 3.97 |
| Zn (ppb) | <DL | 1.78 | 7.91 |
| Pb (ppb) | <DL | <DL | 0.18 |

“<DL” indicates below detection limit

Particles in an immersion liquid, e.g., water, can deposit on a wafer or cast a shadow during the lithographic exposure that can cause defects. These particles can be removed down to about 0.03 micron (em) or smaller using filtration. These particles can include undissolved silica. For example, a 0.03 μm or smaller rated, all Teflon® material filter that is non-dewetting and has very low or essentially no TOCs (for example a QUICKCHANGE® filter from Entegris Inc. (QUICKCHANGE® is a trademark of Entegris, Inc., Chaska, Minn.)) in a disposable format can be used to minimize the handling contamination and remove the undissolved and undegraded contaminant. Such a filter uses non-dewetting technology, exhibits high particle retention: LRV (logarithmic reduction value) greater than 2.5 of 0.03 μm particles (greater than 99.7% removal), and has extremely low extractables at levels suitable for an immersion lithography process.

In other versions of the invention, the particle filter can include a membrane such as a 0.02 micron (μm) rated PVDF filter such as, but not limited to, DURAPORE® Z from Millipore Corp. (DURAPORE® is a registered trademark of Millipore Corporation, Bedford, Mass.) This 0.02 μm rated polyvinylidene fluoride (PVDF) based filter is also very efficient for particle removal from an immersion fluid, e.g., water, and has extremely low extractables at levels suitable for an immersion lithography process.

The particle filter, e.g., a sieving filter membrane, useful for the present invention can have charge that ranges from a positive charge to neutral charge in the liquid that is being filtered. For example, DURAPORE® Z filters use a polyvinylidene difluoride (PVDF) membrane in a pleated cartridge device. The supports, cage, and core of the filter are polypropylene. The surface of the DURAPORE® Z membrane is modified or coated and it becomes positively charged in water. In addition to removing particles larger than 100 nm by sieving, the DURAPORE® Z filter can capture essentially all negatively charged particles including those smaller than the pores of the membrane. Since most contaminating particles in water have a negative charge, a positively charged membrane can be used. Because DURAPORE® Z has complete removal, 2 LRV or greater or in some cases 3 LRV or greater, for 20 nm colloidal silica, the filter can be described as having a pore size rating of 20 nm (0.02 μm).

Another example of a suitable particle filter that can have a positive charge is a nylon filter that uses a nylon membrane in a pleated cartridge. Suitable nylon membranes are obtainable, for example, from Membrana GmbH (Wuppertal, Germany). The supports, cage, and core of the filter can be, for example, high density polyethylene (HDPE). The pore size rating of the nylon filter can be about 20 nm. The filter can have a natural positive charge in water, giving it complete, or nearly complete, retention for negatively charged particles like PSL bead and colloidal silica.

Another suitable particle filter is a surface-modified nanoparticle filter, e.g., Entegris, Inc. Part No. S4416M117Y06. A surface-modified nanoparticle filter can contain a surface modified ultrahigh molecular weight polyethylene membrane (UPE) and can be pleated and housed in a cartridge. Membranes suitable for use in the surface-modified nanoparticle filter are described, for example, in International Patent Publication No. WO/2005072487, entitled “Process for Removing Microbubbles from a Liquid,” the entire contents of which is incorporated herein by reference. The supports, cage, and core of the filter can be, for example, high density polyethylene. A modified UPE membrane can be characterized by being spontaneously wettable in water. The surface can be neutrally charged in water, giving it exceptional non-sieving retention of negatively charged and positively charged particles. The filter can be rated at about 20 nm.

The area of the particle filter can be chosen for the pressure drop and flow rate requirements of the application. In some embodiments, the area of the filter can range from about 5,000 cm² to about 15,000 cm². In other embodiments it can range from 7,000 cm² to 11,000 cm². The pore size rating of the filter membranes that can used include those with a sieving pore size rating of about 30 nm or less, about 25 nm or less, or about 20 nm or less.

Filter membranes that can be used can have complete retention, or nearly complete retention, of silica particles, e.g., negatively charged silica particles, of about 30 nm or less, about 25 nm or less, or about 20 nm or less, with about 3 LRV or more for up to about 20 monolayers of silica particle coverage or more than about 20 monolayers. The filter membranes and cartridge of the particle filter can have one or any combination of the following attributes at a liquid flow rate of about 3 liters/min and water temperature of about 20° C. degrees in the apparatus or system: time to reach less than about 10 ppb TOC in about 200 minutes or less, in about 70 minutes or less, and in some cases about 60 minutes or less; time to reach about 18.2 mega-ohm resistivity: about 690 minutes or less, about 470 minutes or less, about 315 minutes or less; time to reach particle specification: about 200 minutes or less, about 150 minutes or less, about 65 minutes or less; particle concentration after about 4 hours outlet from a system or apparatus: about 450 particles/liter or less, about 300 particles per liter or less, about 230 particles per liter or less; and silica removal below detection limit for about 2 ppb inlet challenge or about 1 ppb inlet challenge.

In one embodiment, the particle filter is the last unit operation before the liquid is delivered to a point of use. In such an embodiment, it is important that the particle filter, e.g., a filter membrane and a filter housing, does not release any undesired contamination.

Organic contaminants in UPW or an immersion liquid are undesirable because they can absorb DUV energy from the stepper and can cause defects. These organic contaminants can also deposit on the lens, causing haze and lens performance impairment. These organics (e.g., TOC) can be reduced from the fab UPW feed water from typical ppb levels down to ppt levels at POU with a UV oxidation-ion exchange process. This can be used to reduce the TOC to ppt (part per trillion) levels by breaking down most organic molecules into CO₂ and H₂O (in some case other oxidized organics containing carboxylate or other charged groups can be produced and removed by ion exchange rather than degassing). Degassing is illustrated, for example, in FIG. 1A and FIG. 1B as well as in the embodiment in FIG. 3. In each of these embodiments, a degasser and an additional purifier is disposed between the UV oxidation unit and the ion exchange unit.

The ion exchange units can be used along with a polishing degasser to remove CO₂. TOC reduction is affected by the flow rate (residence time) through both the oxidation or degradation unit and the purifier. Low TOC liquid (e.g., low TOC water) can also be achieved by using pre-cleaned system components, with reduced leachables and TOC. This can be accomplished, for example, utilizing UPW water flushing, hot water flushing or extraction using UPW, or other similar treatments of the apparatus components to reduce residual TOCs. The flushing can continue until the inlet TOC matches the outlet TOC from the flushing.

Where high levels of incoming TOCs exist, a separate bed of carbon-removing material can be incorporated into the flow path of the apparatus. For example, a resin that removes both TOCs and ions such as ORGANEX™ resin (from Millipore Corporation) or other similar material can be used.

Ion removal from UPW to ppt level is specified in the 2005 International Technology Roadmap for Semiconductors (ITRS) guidelines. A mixed-bed ion exchange unit can be used to effectively deionize the UPW to ppt level ions at the POU in versions of the apparatus and methods of the present invention. The components and mixed bed ion exchanger can be fashioned to meet the ITRS guidelines and not add any ionic impurities. The apparatus in embodiments of the invention can remove TOC's and/or TOx (for example, sulfur, nitrogen, halogen, phosphorus containing organic compounds) by purifier resin, ion exchange (e.g., mixed ion exchange) and/or degassing.

Degassing the immersion fluid to remove bulk dissolved gases or to remove volatile oxidation degradation products from the fluid can lead to variations in fluid temperature. A high purity degasser such as the PHASOR® II (Entegris, Inc.) can be used. For example, vacuum degassing following a UV oxidation unit can lower the temperature of water or UPW due to evaporative cooling. For immersion lithography applications, maintenance of the liquid (e.g., water) temperature is important for consistency in the refractive index. High purity, low TOC producing heat exchangers can be used in versions of the invention to condition the temperature of the immersion fluid to a setpoint temperature in the range of from about 15° C. to about 30° C. (or where the refractive index of the fluid is about at its maximum) and maintain it to about +0.01° C. or less at an outlet of the exchanger or at the point of use.

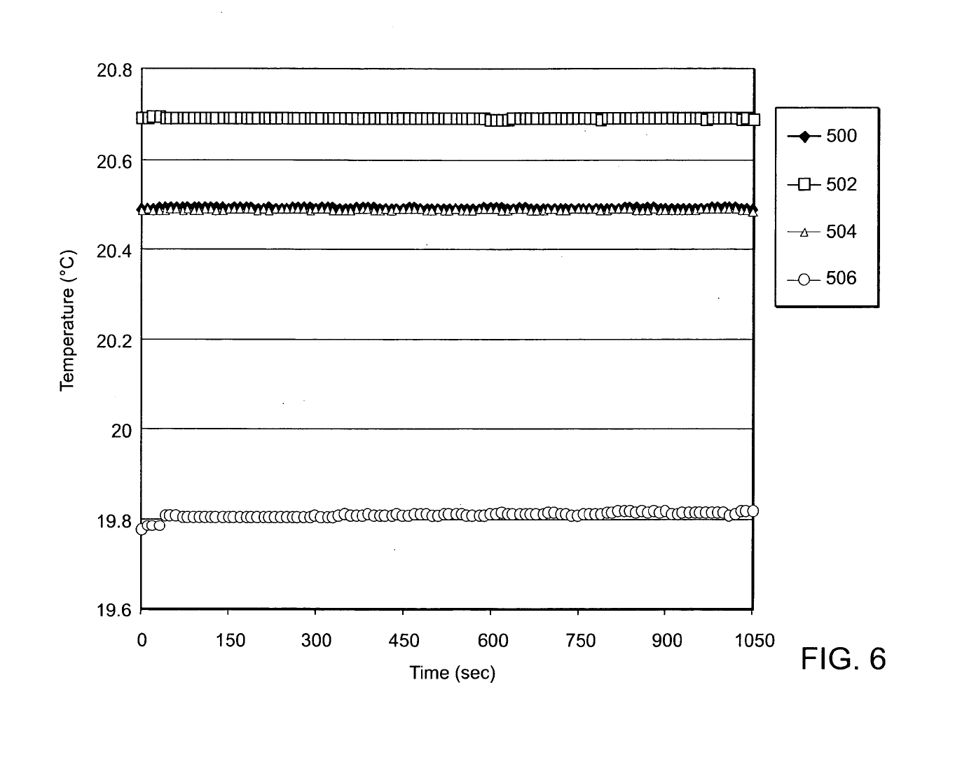

A stable water temperature prevents immersion lithographic imaging defects by eliminating refractive index changes. To reduce fluctuations of refractive index resulting from temperature changes in the immersion liquid, and to prevent contamination by ions of organics, a perfluorinated heat exchanger can be used to maintain the temperature of the immersion fluid in a predetermined temperature range (window) of less than about ±0.01° C. as shown in FIG. 6. In some embodiments, the heat exchanger can be used to maintain the temperature of the immersion fluid in a predetermined range or window of less than about ±0.002° C. In some embodiments the variation in the temperature of the immersion liquid from the apparatus or to the point-of-dispense can be about ±0.001° C. or 1 mK or less.

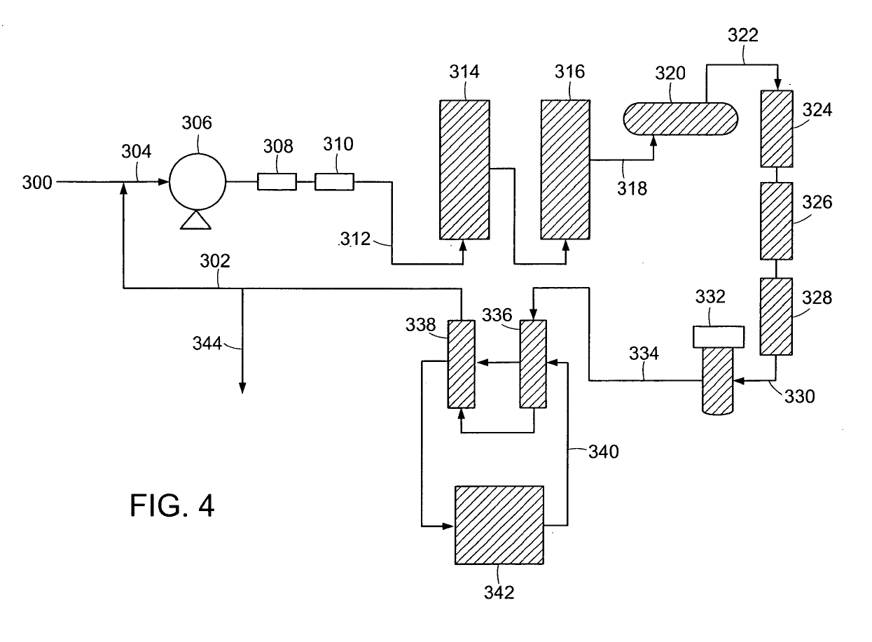

In embodiments of the apparatus and methods for making high purity immersion fluid (e.g., water), a portion of feed liquid (e.g., feed water such as degassed feed water or treated water) may be used as an exchange fluid in the heater/chiller (e.g., chiller 342 of FIG. 4 such as a Neslab Chiller) to temperature condition the liquid delivered to the immersion lithography system from the outlet of the heat exchangers (one or more heat exchangers, e.g., heat exchangers 336 and 338 as shown in FIG. 4 such as PHASOR® X from Entegris, Inc.). While the exchange or working fluid of the heater/chiller can re-circulate in a closed loop, the amount of dissolved gas in the exchange or working fluid can be controlled by further degassing, inert gas purging, blanketing, or a combination thereof, the exchange fluid. Additionally, a nitrogen or other inert gas purge may be used to minimize or eliminate permeation and diffusion of atmospheric gases through thermoplastic conduits of the apparatus and/or hollow tubes of the heat exchanger. Blanket or purge gases that can be used include those that have low solubility in the immersion fluid, have low permeation and diffusion in thermoplastics of the apparatus, and are chemically compatible with the immersion fluid. Such an inert gas purge can be utilized to maintain the high resistivity of the product immersion liquid and exclude atmospheric gases such as carbon dioxide and oxygen from the immersion fluid. In some embodiments the amount of dissolved gas in the treated liquid is below the saturation level of the gas in the liquid, for example less than about 8 ppm for oxygen in an immersion liquid (e.g., water). In other embodiments, the amount of dissolved gas in the treated liquid is below about 1000 parts per billion, in some embodiments less than about 200 ppb, and in still other embodiments less than about 20 ppb.

In some versions of the invention the chiller in the apparatus can be filled manually with liquid (e.g., water) that has been produced using the apparatus at start up and can then be automatically filled from the system, for example, as indicated by a level sensor, during operation of the apparatus. Also, there can be a nitrogen or other inert gas bubbler that keeps a nitrogen or inert gas blanket continuously over the exchange fluid in the exchanger.

“Treated liquid” refers to a liquid conditioned by the degasser, oxidization unit, degasser (e.g., a polishing degasser), purifier, ion exchange bed (e.g., a mixed ion exchange bed), filter, and heat exchanger. The treated liquid can be an immersion fluid having a refractive index above 1.

The purifier can be a bed of material used to remove particulate, colloidal, molecular contaminants, or combinations of these contaminants from the liquid where these contaminants are characterized in that they can degrade the immersion lithography yield and/or create residues on substrates and are not, or may not, be removed by other components of the system such as an ion exchanger, oxidation unit, filtration membrane or degasser. While reference has been made to silica and a silica purifier, the present application is not limited to removal of silica and to apparatus having a silica purifier. Other contaminants that can be removed by practicing the present invention can include, but are not limited, to silicon-containing contaminants, boron-containing contaminants, and carbon-containing contaminants. Purifiers suitable for use in the present invention can have beds of materials for removing such contaminants. The location of the purifier is not limited to being downstream of the degasser and in some versions can be placed for example before the degasser or oxidation unit depending upon the contaminant to be removed by the purifier and its effect on downstream components of the system.

In some embodiments the treated liquid can be used in the immersion lithography process and then discarded. In other embodiments the treated liquid can be removed from the lens and further treated or re-circulated to remove any extractables picked-up from the substrate and then reused. In this case, the liquid can be reintroduced into the system at a variety of points such as at the inlet of feed liquid 10 as shown in FIG. 1A or at other points such as before the purifier or the degasser.

In some versions, a second stage heat exchange system can be used, which can be a “polisher” that adjusts the final temperature of the liquid (e.g., water) from the apparatus (e.g., the apparatus of FIG. 1A) where the point of use is close to a wafer or other substrate.

A flow control module in the system can be used to maintain a highly repeatable and stable flow rate through the lithography system's illuminated area. The flow rate can be chosen for a particular lens configuration such that bubbles are minimized or eliminated on filling. Further, the flow rate can be chosen to prevent or eliminate any contaminants from the substrate that are incorporated into the treated liquid away from the lens. The flow rate can be chosen to keep contaminants or extractables from the substrate in the boundary layer of the treated liquid. For example, the apparatus can deliver a stable UPW flow precisely/repeatedly to the illuminated area to prevent bubble attachment to the wafer or to the lens during the filling process. The precision of the flow system can be about 5% of full scale or less, in some embodiments about 2% of full scale or less. The water-filling rate over the wafer topography can remove resist reaction products, water-soluble resist components, and the heat generated during the exposure such that the temperature and refractive index of the immersion liquid is within process limitations. In some versions the flow rate control required is in the range from about 0.4 to about 1 L/min at a steady state. A slower flow rate at initial fill can be used to ensure complete filling under the lens. This can be followed by a faster flow rate during scanning to ensure by-product removal and meniscus integrity during stage movement. In some embodiments water or other immersion flow rates of up to about 3 L/min full scale can be used.

Some embodiments of the apparatus and method of treating liquid (e.g., water) deliver an immersion liquid with low total oxidizable carbon concentration, particle concentration and dissolved oxygen level for immersion lithography at 193 nm, and in some embodiments, at 65 nm.

One embodiment of the apparatus and process of the present invention reduces total oxidizable carbon by up to about 80% and dissolved oxygen by about 95% from the plant or fab feed water or other inlet UPW source, for example, as illustrated in Example 5 infra.

Currently available water treatment Systems use ion exchange resin to deionize house water to produce a higher purity water, but this does not produce low silica levels desirable for immersion lithography.

Specialized purification processes such as those using Type I strong base ion exchange resins, macroreticular resins, charged microporous membrane filtration, ultrafiltration, or a combination of these can be used as a purifier to remove silica, boron, a combination of these, or to remove separately or in addition to other similarly charged contaminants from an immersion liquid, like water.

Type I anion exchange resin can be effective in removing reactive silica. Macroreticular, charged microporous and ultrafiltration processes can be effective for removing non-reactive and colloidal silica. In some embodiments the silica level achieved is below about 500 ppt, in some versions less than about 350 ppt, in other versions less than about 50 ppt. In versions of the invention the dissolved silica removal efficiency unexpectedly increases as flow rate through the purifier increases. Flow rate of immersion fluid through the purifier can be chosen to minimize channeling effects and provides good contact between water or other immersion fluid and resin. The purifier resin, for example, a strong base anion exchange resin, can be further treated by flushing with low TOC and low ionic containing immersion liquid, for example UPW water, to reduce TOC's from the resin to less than about 20 ppb, and in some cases less than about 5 ppb. In some versions the flushing continues until no additional TOC is added to the incoming UPW.

A strong base anion exchange medium, in some embodiments Type I, can be used to remove dissolved silica. For example, Type I strong base anion exchange resin can be used. The major resin manufacturers offer such resins, for example, ResinTech, Inc., West Berlin, N.J.; Dow Chemical Company, Midland, Mich. (e.g., Dowex™ resins); Rohm and Haas Co., Philadelphia, Pa.; QualiChem, Inc., Salem, Va.; and Bio-Rad Laboratories, Hercules, Calif. Silica can be removed to less than about 350 ppt and in some cases less than about 50 ppt. To prevent the inadvertent introduction of boron contamination during an immersion lithographic manufacturing processes, in some embodiments the purifier and apparatus can remove boron (and temperature condition, TOC less than about 5 ppb, and degas) from an immersion liquid like water to a very low residual level, typically to a boron low threshold under about 50 ppt (parts per trillion), in some cases a boron level of less than about 20 ppt, and in still other cases a boron level of less than about 10 ppt. In some cases the purifier can remove a combination of dissolved silica and dissolved boron species (and also temperature condition, TOC less than about 5 ppb, and degas the immersion liquid) to less than about 50 ppt for dissolved silica and less than about 10 ppt for boron. One boron-specific exchange resin that may be used in the purifier for such applications is AMBERLITE™ IRA-743T, manufactured by Rohm and Haas Company. In some versions the purifier resin can be the same as an anion exchange resin in the ion exchange unit (e.g., a mixed bed ion exchange unit).

A mixed ion exchange bed's (MBD) performance can be modified by changing the type of anion exchange resin. For example, ResinTech MBD-10 (ResinTech, Inc., West Berlin, N.J.) uses ResinTech SBG1 (ResinTech, Inc.), standard porosity gel Type I resin, which has a higher operating capacity in polishing applications where the major anion load is from silica and bicarbonates. The ResinTech MBD-15 (ResinTech, Inc.) uses a highly porous Type I gel resin, ResinTech SBG1P (ResinTech, Inc.), that gives better performance with high percentages of chlorides in water. The composition of the purifier and/or ion exchange beds can be modified to remove contaminants based on feed liquid composition to provide immersion lithography grade immersion liquid.

In some embodiments the purifier, for example, having a strong ion exchange medium, can be flushed with about 18.2 MΩ-cm water to reduce any TOC. In some embodiments the purifier (e.g., a silica purifier) can be prepared using a column with a Type I strong base anion exchange resin (about 6″-about 8″ long, about 0.5″-about 1″ diameter). The column can be flushed with DI water of at least about 18 MΩ-cm to remove residual TOC (to less than about 20 ppb) and other contaminants.

Removal of contaminants like silica or boron result in a higher purity UPW with low silica and can provide immersion lithography water that does not produce “streak” or “water mark” on a wafer. POU purification of immersion water using these specialized anion exchange resins in versions of the invention can reduce silica in the water and can provide an improved lithography process.

Measuring silica in water can be determined by: Colloidal Silica=Total Silica−Dissolved Silica. To measure Dissolved Silica the most common method is colorimetry with a detection limit of about 0.05 ppb. For Total Silica, the most common method is ICP-MS with a detection limit of about 0.5 ppb (commercially available detection limit).

Analytical techniques for silica in aqueous solutions are based upon the formation of highly colored silicomolybdate complexes. The standard test based on the blue reduced silicomolybdate complex measures only soluble silica, it does not measure highly polymerized or colloidal silica, and is thus limited to concentrations below about 100 ppm. For ppb-ppt level measurements GFAA, ICP-MS, or UV-VIS spectrophotometer techniques can be used.

Analytical methods can include those disclosed in U.S. Pat. No. 5,518,624, the entire contents of which are incorporated herein by reference in its entirety.

Silica can be detected by ICP-MS. The apparatus can first be cleaned and flushed with ultra high purity water, in some cases having a resistivity greater than about 18 mega-ohm and TOC less that about 20 ppb to eliminate any organic extractable that may leave residue upon drying and interfere with the measurement. Next colloidal silica can be spiked in the purified water and analyzed. The solution can be left standing for several days to dissolve the colloidal silica and form reactive silica in the ppt range. These spiked solutions can be used for testing the apparatus in embodiments of the invention. Macroreticular resin and UV oxidation and ion exchange can be used to lower the TOC in water if it interferes with silica detection.

Various components can be referred to as high purity, for example the heat exchanger, degasser, particle filter, or other apparatus components. This means that the components can be made of low TOC emitting or extracting materials (less than about 200 ppb in some versions and less than about 20 ppb in other version), can have low ionic extractables (see, for example, extractables in Table 1), can have low particle shedding, and can have low oxygen permeation. In one embodiment, the components can be blanketed with an inert gas to reduce oxygen or carbon dioxide permeation. These components can receive partially treated immersion fluid, like water, at an inlet of the component and produce further treated immersion fluid at an outlet of the device.

Heat exchangers suitable for use in the invention can minimize or eliminate addition of TOCs to the process stream. For example, in one embodiment, a high purity thermoplastic heat exchanger such as a heat exchanger constructed of perfluorintaed materials is used. The heat exchanger can be used to compensate for cooling from degassers and heating from oxidation or degradation units which can contain UV lamps. Thermoplastic heat exchangers can be preferred over all metal heat exchanger systems due to lower heat conduction which can make it easier to maintain point of use temperature and purity.

For specific applications, it can be desirable to provide a stable supply of high purity liquid, e.g., high purity water. In some embodiments, the apparatus and methods of the present invention can be used to provide a stable supply of high purity liquid, e.g., high purity water. For example, practice of the present invention can provide a relatively constant volumetric flow of liquid, a flow of liquid at a relatively constant pressure, and/or a flow of liquid at a relatively constant temperature. It has been discovered that the stable supply of high purity liquid, e.g., water, that is provided by the present invention is particularly suited for use in immersion lithography systems. Without wishing to be held to any particular theory, it is believed that the high purity liquid provided by the present invention provides added stability to the water lens of the immersion lithography system. For example, the high purity liquid provided by the present invention is thought to assist in maintaining the size and/or shape of the water lens.

In some embodiments, practice of the present invention can provide a stream of high purity liquid, e.g., high purity water, that has a volumetric flow, a temperature, and/or pressure that is dampened as compared to a feed liquid such as feed water, e.g., degassed feed water. In some embodiments, the feed liquid has pressure, temperature, and/or volume fluctuations that can affect the pressure, temperature, and/or volume of a liquid delivered to an immersion lithography system. In other embodiments, one or more pumps within the apparatus can provide pressure, temperature, and/or volume fluctuations that can affect the pressure, temperature, and/or volume of the water delivered to an immersion lithography system. By reducing or eliminating fluctuations in the pressure, temperature, and/or volume of the high purity liquid delivered to, the immersion lithography system, it has been found that a more stable water lens, and thus improved lithography, results. In some embodiments, the apparatus and method can be used to provide a dampening ratio of pressure, temperature, and/or volume, inlet amplitude to outlet amplitude, of about 1 to about 5. In one particular embodiment, the dampening ratio is about 2.

Without wishing to be held to any particular theory, it is believed that the compliant nature of some components of the apparatus described herein contributes to dampening of fluctuations in a feed liquid such as feed water, e.g., degassed feed water. For example, components such as hollow fiber degassers, membrane filters, ion exchange resin beds, and/or hollow tube heat exchangers can contribute to dampening of the fluctuations in the feed liquid. In some embodiments, the present invention can provide a relatively stable supply of high purity liquid, e.g., high purity water, without using a pressure control system, for example, a closed-loop pressure control system. However, in some embodiments, the present invention can also include a pressure control system such as a closed-loop pressure control system.

In some instances, the apparatus described herein further includes a pressure dampening device. A pressure dampening device can reduce fluctuations in pressure and/or volume of a liquid ultimately delivered to an immersion lithography system. The pressure dampening device can include a pulsation dampener. One example of a suitable pulsation dampener is an Accu-Pulse Pulsation Dampener (Primary Fluid Systems, Inc.; Ontario, Canada). Those of ordinary skill in the art are capable of selecting and sizing specific pressure dampening devices in light of the teachings contained herein and based upon specific process requirements. In some embodiments, multiple pressure dampening devices are used.

The pressure dampening device can be located anywhere within the apparatus described herein. A pressure dampening device can be used to dampen a liquid stream selected from the group consisting of a feed liquid, a liquid containing oxidation degradation products, and a temperature conditioned liquid. For example, a pressure dampening device can be used to dampen a water stream selected from the group consisting of feed water (e.g., degassed feed water), feed water containing oxidation degradation products (e.g., degassed feed water containing oxidation degradation products), and temperature conditioned water (e.g., temperature conditioned degassed water). In some embodiments, one or more pressure dampening devices can be used to dampen liquid streams flowing from a degasser, a purifier, a particle filter, and/or a heat exchanger. In one embodiment, a pressure dampening device is used to dampen the feed liquid, e.g., water. In some embodiments, a pressure dampening device is used to dampen a high purity liquid outlet stream, e.g., a high purity water outlet stream.

In some embodiments, the pressure fluctuation between the feed liquid, e.g., degassed feed water, inlet and the high purity liquid outlet is less than about 20 kPa such as, for example, less than about 15 kPa, less than about 10 kPa, or less than about 5 kPa.

FIGS. 8A-C are charts of degassed feed water inlet pressure, pump outlet pressure, and high purity water outlet pressure, respectively, over time for an embodiment of the present invention which did not contain an added pressure dampening device such as a pulsation dampener. Table 2, below, shows the average, maximum, and standard deviations for the data of the charts. The apparatus was operated with a recirculation rate of about 6 liters per minute.

TABLE 2

| | | | Standard |
|---|---|---|---|
| Fluctuation (kPa) | Average | Maximum | Deviation |
| Inlet/0.5 sec | 3 | 25 | 3 |
| Outlet/0.5 sec | 2 | 11 | 1 |
| Pump Outlet/0.5 sec | 6 | 27 | 4 |
| Inlet/1.0 sec | 2 | 9 | 1 |
| Outlet/1.0 sec | 1 | 7 | 1 |
| Pump Outlet/0.5 sec | 3 | 15 | 2 |

FIG. 9 contains charts of degassed feed water inlet pressure and high purity water outlet pressure over time for an embodiment of the present invention which also did not contain an added pressure dampening device such as a pulsation dampener. The apparatus was operated with a recirculation rate of about 6 liters per minute.

FIGS. 8A-C and 9 demonstrate that, in some embodiments, the present invention can provide a stable supply of high purity liquid such as high purity water. Also, FIGS. 8A-C and 9 show that, in some embodiments, fluctuations from a feed liquid and/or due to pumps within the apparatus can be reduced or substantially eliminated by practicing the present invention.

### Example 1

This example illustrates the results for silica removal from water using a single silica purifier, a Type I strong base anion exchange resin, in a single pass process, The results show that a single purifier demonstrates greater than 70% dissolved silica removal efficiency of a 0.33 ppb dissolved silica feed into the purifier.

It was observed that the amount of dissolved silica was less than 0.05 ppb (detection limit) after 1 day and 6 days at the purifier outlet. It was also observed that dissolved silica removal efficiency increased as flow rate increased. Without wishing to be bound by any particular theory, higher flow rate is thought to have minimized channeling effect in the purifier bed and provided good contact between water and resin.

There was no significant amount of TOC shedding from the Si purifier resin.

### Example 2

This example provides test results for an embodiment of the apparatus as illustrated in FIG. 2. FIG. 2 shows a single pass purification process wherein immersion fluid 100, in this example main loop deionized water, was directed into purifier 102. Purifier 102 was a Si purifier. Purified water stream 104 from purifier 102 was directed through particle filter 105. Particle filter 105 was a 0.02 micron DURAPORE® Z filter. Filtered water stream 106 was directed from particle filter 105 to particle counter 108 (UDI 50). Samples were collected after particle counts had been low and stable.

FIG. 3A shows total silica level in ppb for the main loop deionized water (200), for purified water stream 104 (202), and for filtered water stream 106 (204). The total silica removal efficiency was approximately 60% for a single pass. FIG. 3B shows dissolved silica level in ppb for the main loop deionized water (206), for purified water stream 104 (208), and for filtered water stream 106 (210). Dissolved silica level for purified water stream 104 (208) and for filtered water stream 106 (210) were below the detection limit (i.e., less than 0.05 ppb). The dissolved silica removal efficiency was greater than approximately 70% for a single pass.

Results indicate that the apparatus is effective in removing dissolved silica from a feed at a concentration of 0.14 ppb to less than 0.05 ppb at the outlet of the Si purifier or the outlet of the filter. The silica removal cartridges were prepared using Type I strong base anion exchange resin.

Some colloidal silica removal was observed, 4.9 ppb to 2-2.5 ppb, however handling (prior use) of the DURAPORE® Z filter may have reduced its effectiveness.

The results illustrate dissolved silica removal and colloidal silica removal from a feed of water.

### Example 3

This example describes experiments wherein improved handling procedures were used with the filter. This example used the apparatus illustrated in FIG. 4. House deionized (DI) water 300 was combined with recirculated water stream 302 to form combined stream 304 which was directed to pump 306. Pump 306 transferred combined stream 304 to degassers 308 and 310. Degassed water stream 312 was directed to UV oxidation units 314 and 316. Resulting UV-treated water stream 318 was then directed to PHASOR® II high purity degasser 320. The resulting water stream 322 was directed to Si purifier 324 and mixed bed purifiers 326 and 328 to produce purified stream 330. Purified stream 330 was then directed into DURAPORE® Z 0.02 micron cartridge filter 332 to produce filtered water stream 334. Filtered water stream 334 was then directed to heat exchangers 336 and 338. Heat exchangers 336 and 338 were supplied with cooling water 340 provided by chiller 342, e.g., a NESLAB chiller. Recirculated water stream 302 exited heat exchanger 338. Stream 344 was used to collect liquid samples. Stream 344 could also be connected to a point of use.

The apparatus of FIG. 4 was operated under the following operating conditions: pump 306 speed was 7000 rpm (bypass valve completely open); system re-circulation rate was approximately 2 gallons per minute (GPM); system bleed rate was approximately 2.5 liters per minute (LPM) (including instrumentation bleed).

Samples were collected after the apparatus had been running over 72 hours; both TOC and resistivity had stabilized.

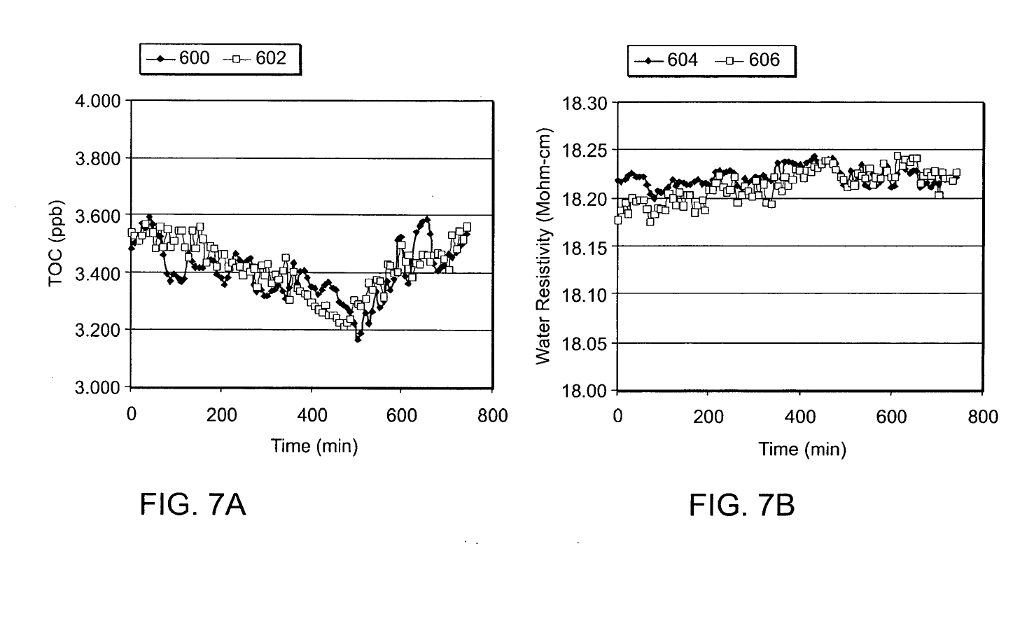

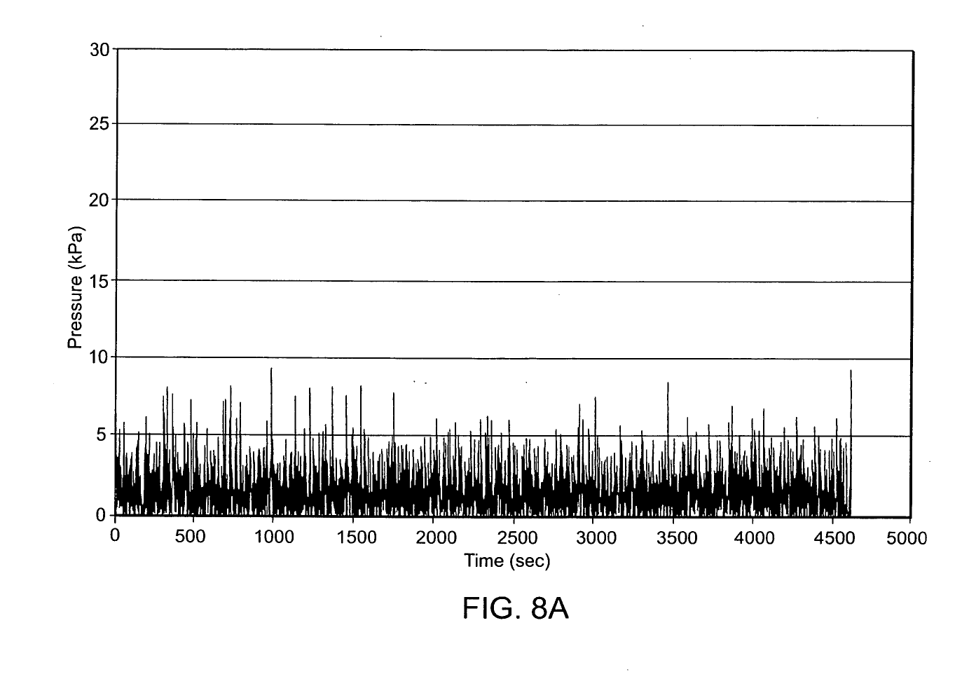

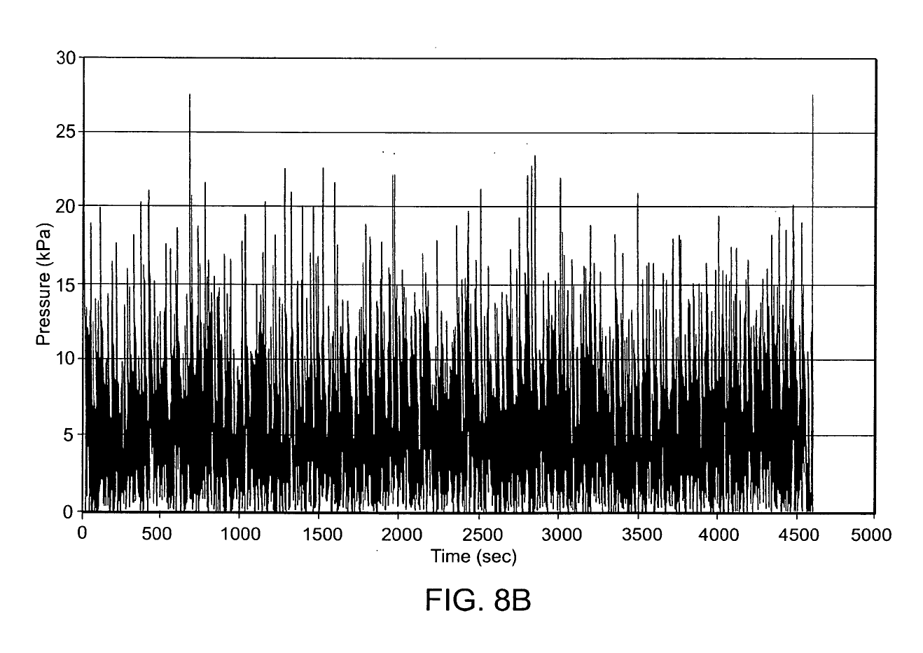

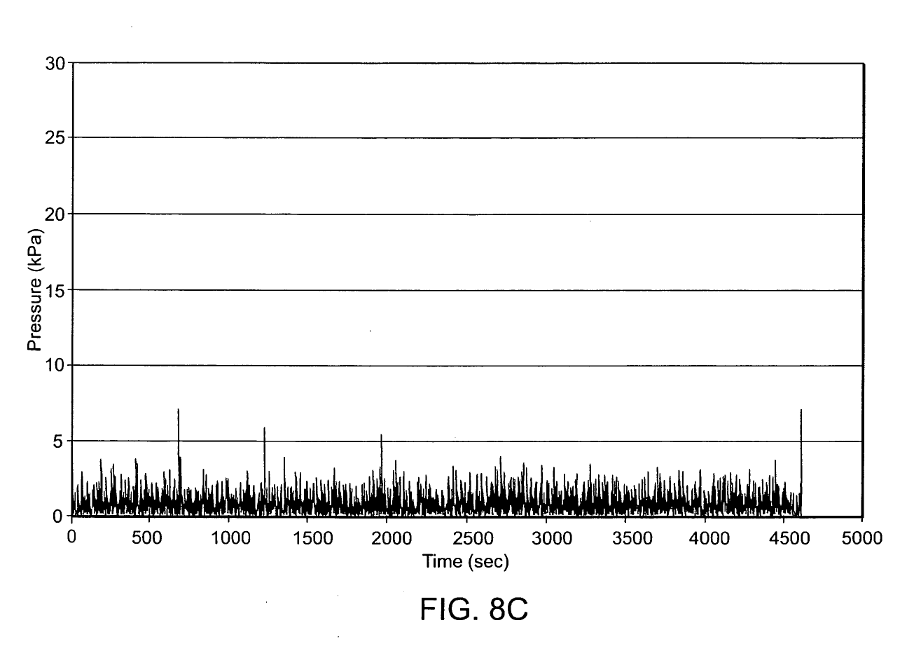

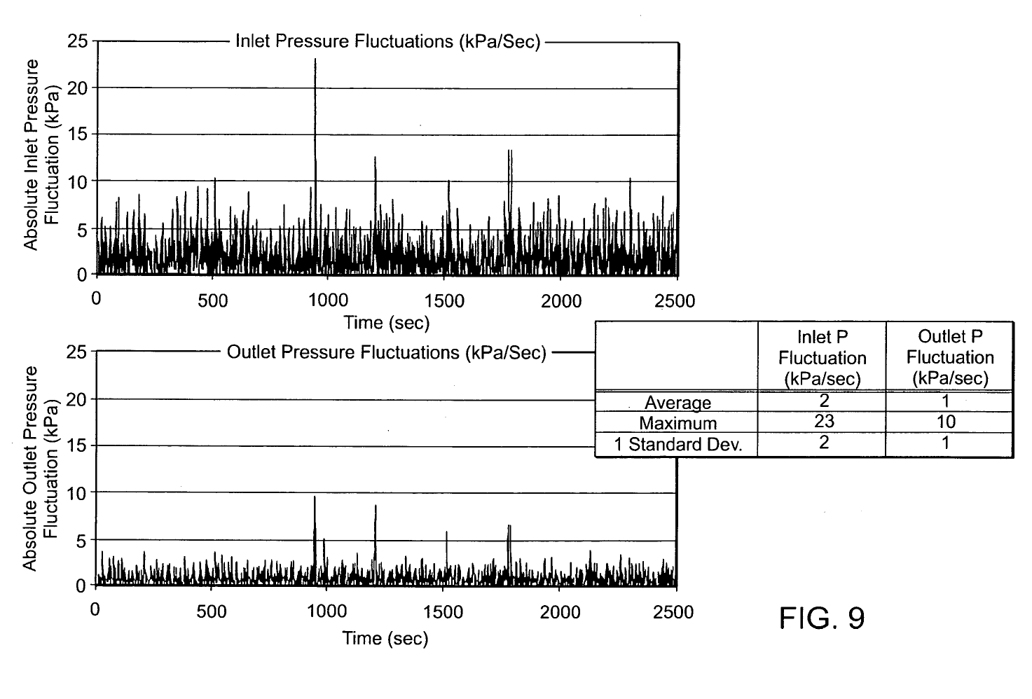

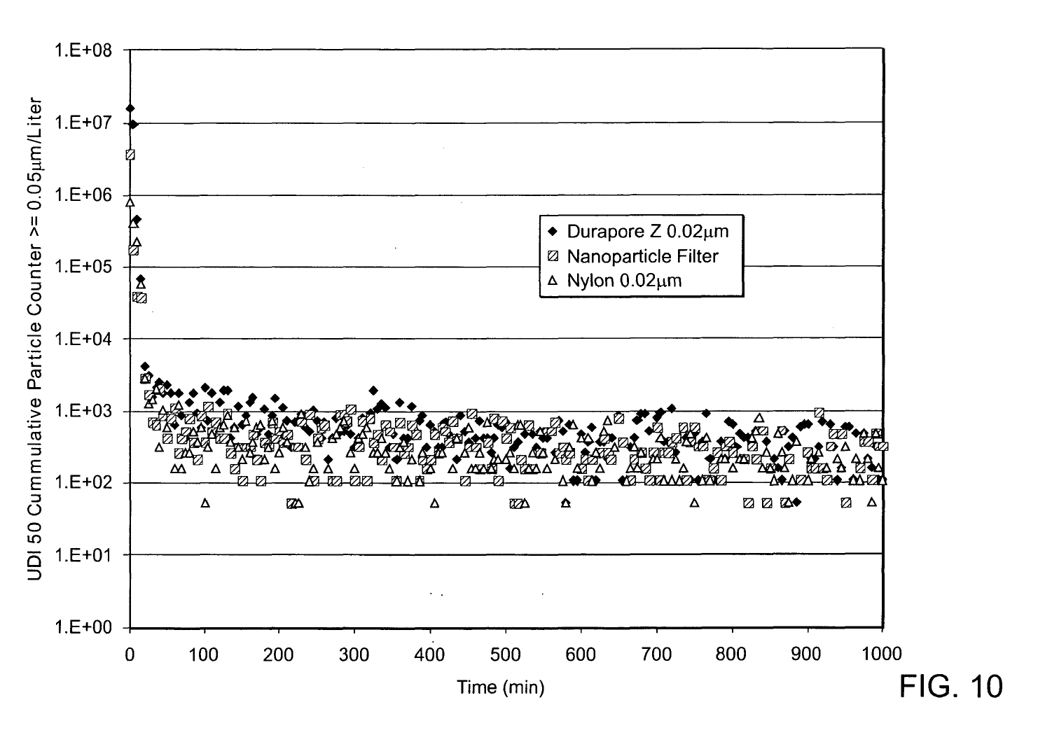

The apparatus of FIG. 4 demonstrated the ability to remove both total and dissolved silica below the detection limit and provide a resistivity between 18.2 and 18.25 mega ohms-cm or higher and TOC less than 4 ppb as shown in FIGS. 5, 7A and 7B.

FIG. 5A shows total silica level in ppb for house deionized (DI) water 300 (400) and for recirculated water stream 302 (402). The total silica removal efficiency was approximately 40% in recirculation mode. Total silica level for recirculated water stream 302 was below the detection limit (i.e., less than 0.05 ppb). FIG. 5B shows dissolved silica level in ppb for house deionized (DI) water 300 (404) and for recirculated water stream 302 (406). Dissolved silica level for recirculated water stream 302 was below the detection limit (i.e., less than 0.05 ppb). The dissolved silica removal efficiency was greater than approximately 85%.

FIG. 6 illustrates that the apparatus is capable of maintaining temperature to within less than 0.1° C. FIG. 6 shows a plot of heat exchanger water jacket return temperature 500, heat exchanger inlet temperature 502, heat exchanger outlet temperature 504, and house DI water temperature 506. The target temperature was 20.5° C., the average house DI water temperature was about 19.81° C., and the average heat exchanger outlet temperature was about 20.49° C.

FIG. 7A shows a plot of TOC v. time for the Si purifier inlet (600) and the Si purifier outlet (602). FIG. 7B shows a plot of resistivity v. time for the Si purifier inlet (604) and the Si purifier outlet (606). The data of FIGS. 7A and 7B were measured using two Sievers PPT TOC Analyzers.

The system showed excellent dissolved silica removal efficiency in a continuous loop.

### Example 4

Table 3 and 4, below, summarize UPW ionic quality delivered by an immersion fluid system illustrated in FIG. 4. Data shows that the system components are clean and do not add ionic impurities to the product water.

TABLE 3

| | Detection Limit | | Inlet | Outlet |
|---|---|---|---|---|
| Aluminum (Al) | 1 | ppt (pg/ml) | 9 | * |
| Antimony (Sb) | 0.2 | ppt (pg/ml) | * | * |
| Arsenic (As) | 2 | ppt (pg/ml) | * | * |
| Barium (Ba) | 0.5 | ppt (pg/ml) | 1.5 | * |
| Bismuth (Bi) | 0.2 | ppt (pg/ml) | * | * |
| Boron (B) | 10 | ppt (pg/ml) | 57.5 | * |
| Cadmium (Cd) | 0.5 | ppt (pg/ml) | * | * |
| Calcium (Ca) | 2 | ppt (pg/ml) | 480 | * |
| Chromium (Cr) | 1 | ppt (pg/ml) | * | * |
| Cobalt (Co) | 0.5 | ppt (pg/ml) | * | * |
| Copper (Cu) | 1 | ppt (pg/ml) | * | * |
| Gallium (Ga) | 0.5 | ppt (pg/ml) | * | * |
| Germanium (Ge) | 1 | ppt (pg/ml) | * | * |
| Iron (Fe) | 2 | ppt (pg/ml) | 16 | * |
| Lead (Pb) | 0.2 | ppt (pg/ml) | * | * |
| Lithium (Li) | 0.2 | ppt (pg/ml) | * | * |
| Magnesium (Mg) | 1 | ppt (pg/ml) | 49 | * |
| Manganese (Mn) | 0.5 | ppt (pg/ml) | 1.7 | * |
| Mercury (Hg) | 5 | ppt (pg/ml) | * | * |
| Molybdenum (Mo) | 0.5 | ppt (pg/ml) | * | * |
| Nickel (Ni) | 2 | ppt (pg/ml) | * | * |
| Potassium (K) | 5 | ppt (pg/ml) | 400 | * |
| Silver (Ag) | 0.5 | ppt (pg/ml) | * | * |
| Sodium (Na) | 2 | ppt (pg/ml) | 200 | * |
| Strontium (Sr) | 0.2 | ppt (pg/ml) | 14 | * |
| Tin (Sn) | 0.5 | ppt (pg/ml) | * | * |
| Titanium (Ti) | 0.5 | ppt (pg/ml) | 3.6 | * |
| Tungsten (W) | 1 | ppt (pg/ml) | * | * |
| Vanadium (V) | 0.2 | ppt (pg/ml) | * | * |
| Zinc (Zn) | 2 | ppt (pg/ml) | 48 | * |

* Below detection limit

In some embodiments of the system or apparatus having a purifier that removes silica, the system has the following properties (Table 4, below) for an feed inlet of UPW water and a treated, temperature-conditioned immersion liquid (outlet).

TABLE 4

| Item | Unit of Measure | Inlet | Outlet |
|---|---|---|---|
| Metal ions | ppb | <1 | <0.01 |
| Anions | ppb | N/A | <0.05 |
| Total Silica | ppb | <1 | <0.5 |
| Bacteria | cfu/liter | <10 | <1 |
| TOC | ppb | <3 | <1 |
| Resistivity | Mohm-cm | >17.7 | 18.2 |
| Bubble/particle | count/ml > | <10 | <0.5 |
| | 0.05 micron | | |
| Dissolved oxygen | ppm | <1 | <0.1 |
| UPW flow rate | LPM | 3 | 3 |
| UPW temperature range | deg C. | 20~26 | 23 |
| UPW temperature stability | deg C. | <1 | <0.5 |
| UPW temperature fluctuations | deg C. per 5 min | <1 | 0.1 |

### Example 5

In various experiments, a DURAPORE® Z filter, a nylon filter (obtained from Membrana GmbH), and a surface-modified nanoparticle filter (Entegris Part No. S4416M117Y06) were installed as particle filter 105 in the apparatus of Example 2. A feed flow rate of 20-40 mL/min and a pressure of 10-15 psi were used. The output of the system was monitored with time for a number of attributes. FIG. 10 shows the particle count>0.05 μm as a function of time after each filter was installed in the system. Table 5 shows the water quality. The surface-modified nanoparticle filter demonstrated superior water quality in less time than the other two filters.

TABLE 5
Comparative Filter Performance

| | | | | | Surface- | |
|---|---|---|---|---|---|---|
| | | | | | Modified | |
| | | | | | Nanoparticle | |
| | DURAPORE ® Z | | Nylon | | Filter | |
| TOC | | | | | | |
| Time to reach inlet TOC | 60 | min | 186 | min | 68 | min |
| level | | | | | | |
| Resistivity | | | | | | |
| Time to reach 17.9 Mohm | 264 | min | 102 | min | 12 | min |
| Time to reach 18.2 Mohm | 684 | min | 465 | min | 312 | min |
| Particles | | | | | | |
| Time to reach <1000 | 210 | min | 70 | min | 65 | min |
| particles (>0.05 μm)/L | | | | | | |
| Particles after 2 hours | 493 | particles/L | 293 | particles/L | 248 | particles/L |
| Particles after 4 hours | 439 | particles/L | 226 | particles/L | 283 | particles/L |
| Silica Removal | | | | | | |
| Inlet Silica | 0.8 | ppb | 1.8 | ppb | 2.0 | ppb |

| | | | |
|---|---|---|---|
| Outlet Silica | <DL | <DL | <DL |

“<DL” indicates below detection limit

While this invention has been particularly shown and described with references to example embodiments thereof, it will be understood by those skilled in the art that various changes in form and details may be made therein without departing from the scope of the invention encompassed by the appended claims.

1. An apparatus, for producing a conditioned immersion fluid for use in an immersion lithography process, having a flow path comprising:
an inlet conduit that supplies a pressurized source of degassed feed water to said apparatus, said degassed feed water has less than about 200 parts per billion dissolved oxygen;
an oxidation unit having an inlet that receives a flow of said degassed feed water and degrades all or a portion of organic contaminants in said degassed feed water into oxidation degradation products; said oxidation degradation products include carbon dioxide, an outlet from said oxidation unit;
a high purity degasser having an inlet that receives water containing oxidation degradation products, said degasser removes all or a portion of said oxidation degradation products from the degassed feed water, said high purity degasser producing degassed liquid,
a purifier having an inlet that receives degassed liquid, said purifier includes a bed of material that removes from said degassed feed water contaminants not degraded by said oxidation unit, said purifier further includes an ion exchange bed, said ion exchange bed removes ionic contaminants from said degassed liquid; said purifier having an outlet for removing said degassed liquid from the purifier;
a particle filter that removes particulates, colloids, gels or a combination of these from said degassed feed water; and
a high purity thermoplastic heat exchanger having an inlet to receive degassed feed water, said heat exchanger conditions the temperature of the degassed feed water, said heat exchanger receives degassed feed water and conditions the temperature of said treated water through a thermoplastic polymer to a temperature for use in an immersion lithography lens; said heat exchanger has an outlet to remove all or a portion of temperature conditioned degassed water from the exchanger to an immersion lithography system.

2. The apparatus of claim 1 further comprising a degasser to remove bubbles and/or dissolved gases from the feed liquid.

3. The apparatus of claim 1 wherein the temperature of said temperature conditioned water is in the range of about 20 to about 30° C. while retaining said electrical resistivity at the heated temperature equivalent to about 18.2 to about 18.25 megaohms at about 20.5° C.

4. The apparatus of claim 1 wherein the purifier comprises a separate bed for removing ionic contaminants.

5. The apparatus of claim 1 wherein the heat exchanger contains hollow tubes.

6. The apparatus of claim 1 wherein the high purity degasser contains microporous hollow fibers.

7. The apparatus of claim 1 further comprising a pump to re-circulate all or a portion of temperature conditioned degassed water through said purifier and said high purity heat exchanger.

8. The apparatus of claim 1 wherein said degassed feed water has a resistivity in the range of about 17 to about 18.2 Mohms-cm at 25° C.

9. The apparatus of claim 1 wherein the point of use is a liquid immersion lithography system.

10. The apparatus of claim 1 wherein the purifier is upstream of said ion exchange bed.

11. A method comprising:
supplying a pressurized source of degassed feed water, said degassed feed water has a resistivity in the range of about 17 to about 18.2 mega-ohms at 25° C., said degassed feed water contains less than about 200 parts per billion dissolved oxygen;
flowing said degassed feed water into an oxidation unit having an inlet that receives said degassed feed water and degrades all or a portion of organic contaminants in said degassed feed water into oxidation degradation products; said oxidation degradation products include carbon dioxide, and removing degassed feed water containing oxidation degradation products from an outlet of said oxidation unit;
contacting said degassed feed water containing oxidation degradation products with a high purity thermoplastic degasser having an inlet that receives said degassed feed water containing oxidation degradation products and removing all or a portion of said oxidation degradation products from the water by the high purity thermoplastic degasser, flowing said degassed feed water through a purifier bed having a material that removes contaminants not degraded by said oxidation unit;
removing ionic contaminants from said degassed feed water by contacting said degassed feed water with an ion exchange bed said ion exchange bed removes ionic contaminants from said degassed feed water;
filtering said degassed feed water to remove particulates, colloids, gels or a combination of these from said degassed feed water; and
conditioning the temperature of said degassed feed water with a high purity thermoplastic heat exchanger having an inlet to receive degassed feed water, said heat exchanger conditions the temperature of the degassed feed water, said heat exchanger receives degassed feed water and conditions the temperature of said degassed feed water through a thermoplastic polymer in contact with a degassed exchange fluid; said degassed feed water conditioned to a temperature for use in an immersion lithography system; said heat exchanger has an outlet to transport temperature conditioned degassed water from the exchanger to the immersion lithography system.

12. The method of claim 11 wherein the purifier bed is between the outlet of the high purity degasser and the inlet of the ion exchange bed.

13. The method of claim 11 wherein the high purity thermoplastic heat exchanger conditions the temperature of degassed feed water that has been treated by said purifier bed.

14. The method of claim 11 wherein the high purity heat exchanger contains perfluorinated thin walled hollow tubes.

15. The apparatus of claim 1 wherein the purifier bed comprises a type strong ion exchange medium flushed with 18.2 MΩ water to reduce TOC.

16. The method of claim 11 wherein the purifier bed comprises a type strong ion exchange medium flushed with 18.2 MΩ water to reduce TOC.

17. The apparatus of claim 1 further including at least one pressure dampening device.

18. The apparatus of claim 17 wherein the at least one pressure dampening device includes a pulsation dampener.

19. The apparatus of claim 1 wherein the particle filter includes a surface-modified nanoparticle filter.

20. The apparatus of claim 19 wherein the surface-modified nanoparticle filter includes a membrane surface that is neutrally charged in water and wherein the filter is rated at about 20 nm.

21. The method of claim 11 further including dampening the pressure of the water.

22. The method of claim 21 further including dampening the pressure of a water stream selected from the group consisting of the degassed feed water, the degassed feed water containing oxidation degradation products, and the temperature conditioned degassed water.

23. The method of claim 21 wherein dampening the pressure of the water includes using a pulsation dampener to dampen the pressure of the water.

24. The method of claim 11 wherein filtering said degassed feed water includes filtering the degassed feed water through a surface-modified nanoparticle filter.

25. The method of claim 24 wherein the surface-modified nanoparticle filter includes a membrane surface that is neutrally charged in water and wherein the filter is rated at about 20 nm.

26. An immersion lithography system comprising the apparatus of claim 1 and a lithography imaging system.
